(19) United States
(12) Patent Application Publication
(10) Pub. No.: US 2012/0082367 A1
(43) Pub. Date: Apr. 5, 2012

(54) METHOD OF FORMING IMAGE OF SEMICONDUCTOR DEVICE, AND METHOD OF DETECTING A DEFECT OF THE SEMICONDUCTOR DEVICE BY USING THE IMAGE FORMING METHOD

(75) Inventors: Jung-hoon Byun, Seoul (KR); Yong-min Cho, Suwon-si (KR); Soo-bok Chin, Seoul (KR); Jae-kwan Park, Suwon-si, Gyeonggi-do, (KR); Seok-woo Nam, Seongnam-si (KR); Tae-yong Lee, Hwaseong-si (KR); Kee-Hong Lee, Seongnam-si (KR); Young-min Kim, Hwaseong-si (KR)

(73) Assignee: SAMSUNG ELECTRONICS CO., LTD., Suwon-si (KR)

(21) Appl. No.: 13/237,993

(22) Filed: Sep. 21, 2011

(30) Foreign Application Priority Data
Oct. 5, 2010 (KR) 10-2010-0096916

(51) Int. Cl. G06K 9/48; G06K 9/00; G06K 9/36

(52) U.S. Cl. 382/149; 382/284; 382/199

(57) ABSTRACT

A method forms an ultimate or final image of a sample by selecting some of a plurality of image frames and integrating the selected frames. The method includes providing a semiconductor device including a region of interest and a peripheral region; obtaining a plurality of image frames each including a region of interest image and a peripheral region image respectively corresponding to the region of interest and the peripheral region; selecting at least some of the plurality of image frames based on a contrast between the region of interest image and the peripheral region image; and obtaining an image of the semiconductor device by integrating the selected image frames.

### CROSS-REFERENCE TO RELATED APPLICATIONS

This application claims the benefit of Korean Patent Application No. 10-2010-0096916, filed on Oct. 5, 2010, in the Korean Intellectual Property Office, the disclosure of which is incorporated herein in its entirety by reference.

### BACKGROUND

The inventive concept relates to a method of forming an image of a semiconductor device, and a method of detecting a defect of a semiconductor device by using the image forming method, and more particularly, to a method of forming an image of a semiconductor device by integrating image frames obtained by using particles emitted when an electron beam is irradiated onto the semiconductor device, and a method of detecting a defect of a semiconductor device by using the image forming method.

Currently, electronic devices are getting smaller and lighter and thus a semiconductor device, i.e., a core component of an electronic device, has to be highly integrated and fine-patterned. Accordingly, ensuring high image quality for a fine-patterned semiconductor device is regarded as an essential requirement for managing the quality of the semiconductor device and effectively detecting a small defect.

### SUMMARY

The inventive concept provides a method of forming an image of a semiconductor device having a fine pattern in order to ensure high image quality of the semiconductor device.

The inventive concept also provides a method of detecting a defect of a semiconductor device having a fine pattern in order to effectively detect a defect of the semiconductor device.

According to an aspect of the inventive concept, there is provided a method of forming an image of a semiconductor device. The method includes providing a semiconductor device including a region of interest and a peripheral region; obtaining a plurality of image frames each including a region of interest image and a peripheral region image respectively corresponding to the region of interest and the peripheral region; selecting at least some of the plurality of image frames; and obtaining an image of the semiconductor device by integrating the selected image frames.

The selecting of at least some of the plurality of image frames may include selecting at least some of the plurality of image frames based on a contrast between the region of interest image and the peripheral region image.

The plurality of image frames may include image frames whose contrasts vary according to time.

The contrast between the region of interest image and the peripheral region image may include a normalized intensity that is a ratio of an intensity of particles emitted from the region of interest to an intensity of particles emitted from the peripheral region.

The selecting of at least some of the plurality of image frames may include calculating the normalized intensities of the plurality of image frames; and selecting from among the plurality of image frames image frames having normalized intensities equal to or greater than a first threshold constant, and the first threshold constant may be β×Î max, where Î_max is a maximum value from among the normalized intensities according to time and β is greater than 0 and equal to or less than 1.

The method may further include re-selecting from among the plurality of image frames image frames having normalized intensities equal to or greater than a second threshold constant; and re-obtaining the image of the semiconductor device by integrating the re-selected image frames, and the second threshold constant may be γ×Î_max, where Î_max is a maximum value from among the normalized intensities according to time and γ is greater than β and equal to or less than 1.

The selecting of at least some of the plurality of image frames may include displaying the plurality of image frames on a display screen; and selecting from among the plurality of image frames on the screen image frames having high contrasts of the region of interest image to the peripheral region image.

The plurality of image frames may be obtained by using particles emitted when an electron beam is irradiated onto the semiconductor device.

The particles may be at least one of secondary electrons, backscattered electrons, Auger electrons, diffracted electrons, and transmitted electrons.

The region of interest may include a defect region having a defect, and the peripheral region may include a normal region having no defect.

The normal region may be adjacent to the defect region.

According to another aspect of the inventive concept, there is provided a method of detecting a defect of a semiconductor device. The method includes providing a semiconductor device including a defect region and a normal region; obtaining a plurality of image frames each including a defect region image and a normal region image respectively corresponding to the defect region and the normal region; selecting at least some of the plurality of image frames; and obtaining an image of the semiconductor device by integrating the selected image frames.

The selecting of at least some of the plurality of image frames may include checking variations in contrast between the defect region image and the normal region image according to time in the plurality of image frames; and selecting at least some of the plurality of image frames based on the contrast.

The checking of the variations in contrast between the defect region image and the normal region image according to time in the plurality of image frames may include checking variations in the normalized intensity according to time, which is a ratio of an intensity of particles emitted from the defect region to an intensity of particles emitted from the normal region.

If the variations in the normalized intensity are greater in an early time period than in a later time period, the selecting of at least some of the plurality of image frames may include selecting image frames corresponding to the early period.

If the variations in the normalized intensity are greater in a late period than in an early period, the selecting of at least some of the plurality of image frames may include selecting image frames corresponding to the late period.

If the variations in the normalized intensity are greater in an early period and a late period than in a middle period, the selecting of at least some of the plurality of image frames may include selecting image frames corresponding to the early period and the late period.

If the variations in the normalized intensity are greater in a middle period than in an early period and a late period, the selecting of at least some of the plurality of image frames may include selecting image frames corresponding to the middle period.

According to yet another aspect of the inventive concept, a system is provided. The system comprises: a device configured to cause particles to be emitted from a sample semiconductor device including a region if interest and a peripheral region disposed outside the region of interest; a detection unit configured to detect the particles emitted from the region of interest and the particles emitted from the peripheral region; and a processor configured to execute an algorithm. The algorithm comprises: obtaining a plurality of image frames from the detected particles, each of the image frames comprising a region of interest image and a peripheral region image respectively corresponding to the region of interest and the peripheral region of the semiconductor device; selecting at least some of the plurality of image frames based on a contrast ratio of each image frame between the region of interest image and the peripheral region image; and obtaining an image of the semiconductor device by integrating the selected image frames.

### BRIEF DESCRIPTION OF THE DRAWINGS

Exemplary embodiments of the inventive concept will be more clearly understood from the following detailed description taken in conjunction with the accompanying drawings in which:

FIG. 1 is a flowchart of a method of forming an image of a semiconductor device;

FIGS. 2 through 4 are diagrams of a scanning electron microscope (SEM) as an exemplary apparatus using the image forming method illustrated in FIG. 1;

FIG. 5 is a conceptual view showing the types of particles emitted when an electron beam is irradiated onto a semiconductor device that is a sample;

FIGS. 6, 20, 24, 28, and 31 are conceptual views showing correlations between image frames and an ultimate or final image in methods of forming an image of a semiconductor device, according to various embodiments;

FIGS. 8, 21, 25, 29, and 32 are graphs showing normalized intensities of image frames according to time in methods of forming an image of a semiconductor device, according to various embodiments;

FIGS. 11, 22, 26, 30, and 33 are diagrams showing alignment of image frames obtained in methods of forming an image of a semiconductor device, on a screen of a display apparatus, according to various embodiments;

FIGS. 7, 9, 10, and 12 are flowcharts of methods of forming an image of a semiconductor device, according to other embodiments of the inventive concept;

FIGS. 13, 18, 19, 23, and 27 are flowcharts of methods of detecting a defect of a semiconductor device, according to various embodiments;

FIG. 15 illustrates sequential SEM images showing variations in contrast of a defect region image to a normal region image according to time;

FIGS. 16 and 17 are exemplary cross-sectional views of a semiconductor device using methods of forming an image of a semiconductor device, according to various embodiments; and

FIG. 34 is a schematic diagram of a system for performing a method of forming an image of a semiconductor device or a method of detecting a defect of a semiconductor device, according to an embodiment.

### DETAILED DESCRIPTION OF THE EMBODIMENTS

The inventive concept will now be described more fully with reference to the accompanying drawings, in which exemplary embodiments of the inventive concept are shown.

The inventive concept may, however, be embodied in many different forms and should not be construed as being limited to the embodiments set forth herein, rather, these embodiments are provided so that this disclosure will be thorough and complete, and will fully convey the inventive concept to one of ordinary skill in the art. In the drawings, the thicknesses or sizes of layers may be exaggerated for clarity.

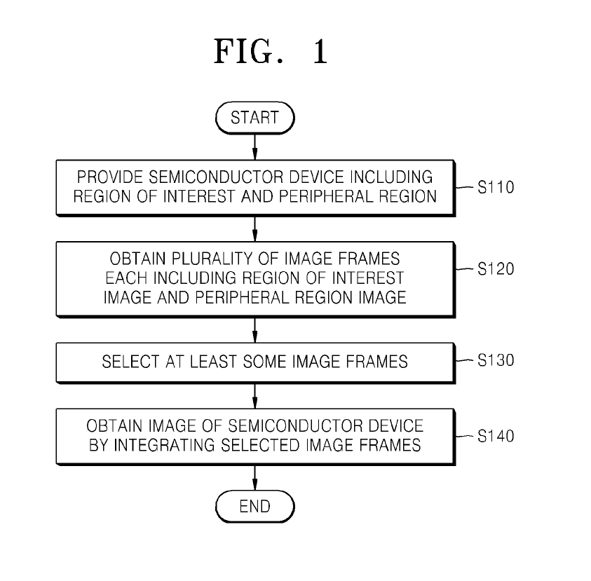

FIG. 1 is a flowchart of one embodiment of a method of forming an image of a semiconductor device.

Referring to FIG. 1, the image forming method includes: providing a semiconductor device including a region of interest and a peripheral region (operation S110) obtaining a plurality of image frames each including a region of interest image and a peripheral region image respectively corresponding to the region of interest and the peripheral region (operation S120), selecting at least some of the image frames (operation S130), and obtaining an image of the semiconductor device by integrating the selected image frames (operation S140).

In the selecting of at least some of the image frames (operation S130), at least some of the image frames may be selected based on a contrast ratio of the region of interest image to the peripheral region image.

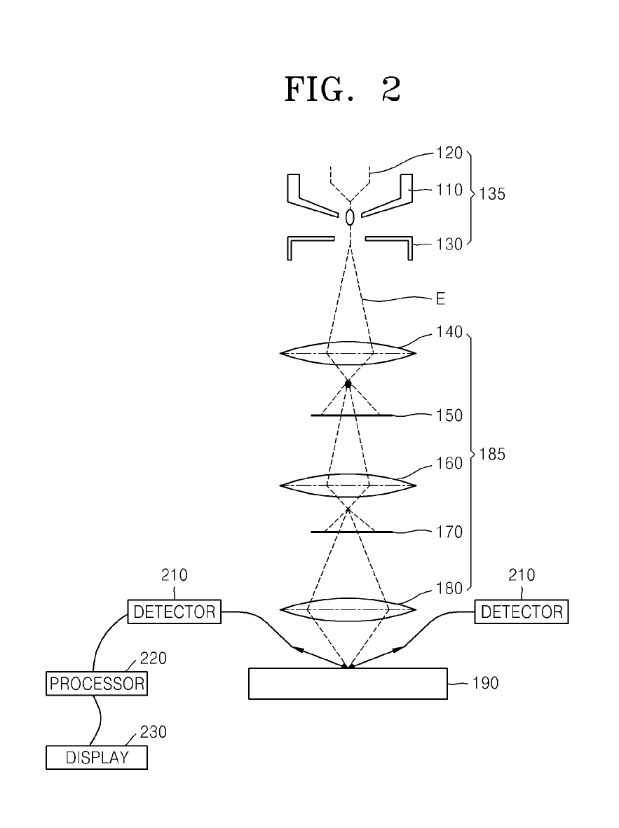

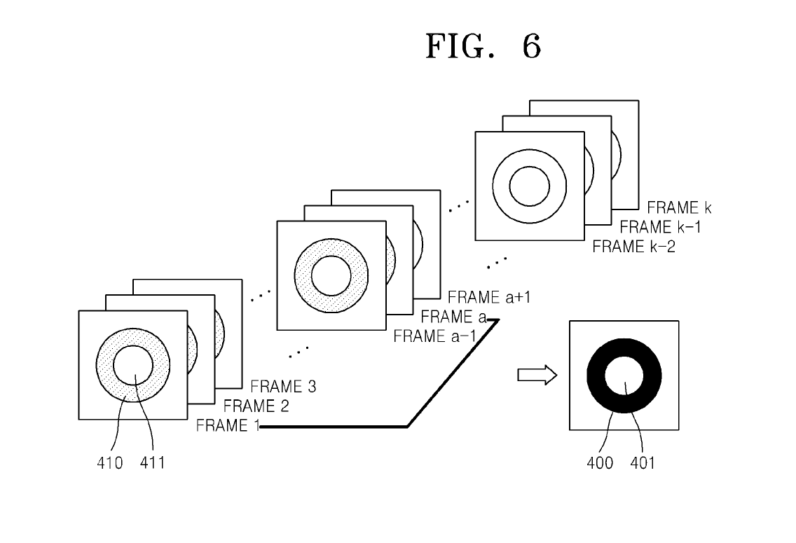

Operations S110, S120, S130, and S140 will now be described in detail with reference to FIGS. 2 through 5 in relation to a scanning electron microscope (SEM) as an exemplary apparatus using the image forming method illustrated in FIG. 1, and FIG. 6 in relation to the structure of image frames.

FIG. 2 is a conceptual view showing a cross section of an SEM.

Referring to FIG. 2, the SEM includes a filament unit 135 for generating electrons, an electron lens unit 185 for focusing and accelerating the electrons, and a detection unit 210 for collecting and detecting secondary electrons and the like. Filament unit 135 includes an electron gun cylinder 110, a filament 120 functioning as a cathode, and an acceleration electrode 130 functioning as an anode, and electron lens unit 185 includes a first focusing lens 140, a first iris 150, a second focusing lens 160, a second iris 170, and an object lens 180. If a voltage is applied to filament 120, filament 120 emits electrons and a series of electron bunches are accelerated toward a semiconductor device 190 due to an electric field applied to acceleration electrode 130. Some electron bunches that pass through holes of first and second irises 150 and 170 are focused by first and second focusing lenses 140 and 160 using magnetic fields so as to form an electron beam E having a uniform wavelength. The electron beam E forms a focus on semiconductor device 190, i.e., a sample, by object lens 180 using a magnetic field. The electron beam E incident on semiconductor device 190 and atoms and electrons included in semiconductor device 190 interact to emit particles such as secondary electrons and backscattered electrons, and detection unit 210 collects the particles to convert the particles into a digital signal. The digital signal is analyzed by a processor 220 (e.g., a calculation apparatus) using an appropriate algorithm, and then is stored or is output on a display screen 230 of a display apparatus.

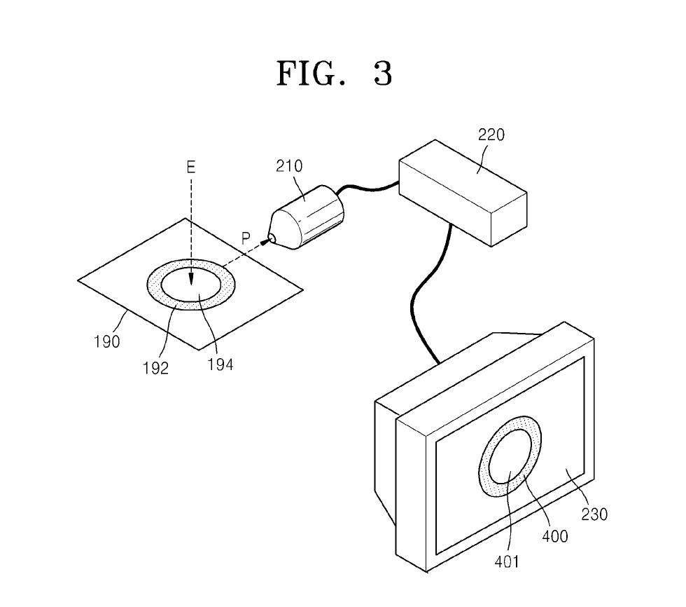

FIG. 3 is a conceptual view showing a process of forming an image of semiconductor device 190 illustrated in FIG. 2, in an SEM.

Referring to FIG. 3, a series of processes are performed on a region of interest 192 and a peripheral region 194 of semiconductor device 190, i.e., a target sample, to ultimately display an image 400 corresponding to region of interest 192 and an image 401 corresponding to peripheral region 194 on display screen 230 of the display apparatus. The image forming method illustrated in FIG. 1 is a method of forming image 400 corresponding to region of interest 192 and image 401 corresponding to peripheral region 194.

Region of interest 192 of semiconductor device 190 includes a region on semiconductor device 190 for which it is desired to form an image, for example, in order to: make a size measurement, detect a defect, and/or check the shape of a pattern. Peripheral region 194 of semiconductor device 190 includes a region on semiconductor device 190 adjacent to region of interest 192. For example, region of interest 192 may be a region including a line pattern, a space pattern, a hole pattern, and/or a trench pattern of semiconductor device 190 and, in this case, peripheral region 194 may be a region adjacent to the line pattern, the space pattern, the hole pattern, and/or the trench pattern. Although region of interest 192 has a ring shape in FIG. 3 for convenient illustration, region of interest 192 may also have one of various shapes such as a rectangle, a square, a circle, an oval, a polygon, a slit, a line, and an indeterminate shape. Also, it will be clearly understood that peripheral region 194 adjacent to region of interest 192 having a ring shape may include an outer circumferential region of the ring shape as well as a central region of the ring shape. Also, region of interest 192 may include a defect region having a defect and, in this case, peripheral region 194 may include a normal region other than the defect region. Peripheral region 194 may be adjacent to region of interest 192.

As such, semiconductor device 190, including region of interest 192 and peripheral region 194, is provided (operation S110 illustrated in FIG. 1).

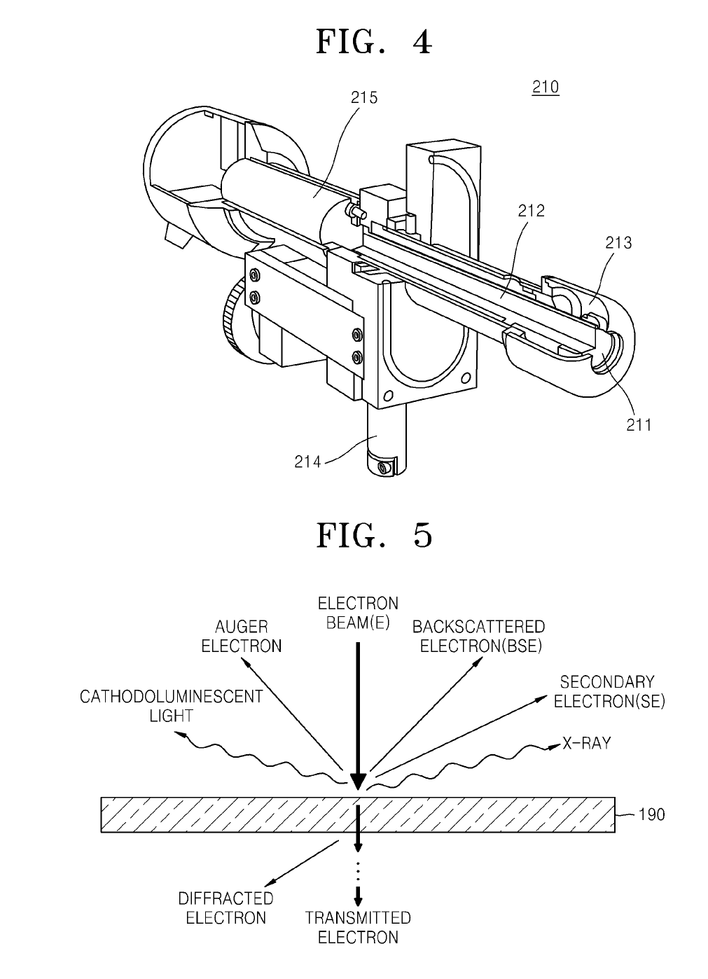

FIG. 4 is a cutaway perspective view of detection unit 210, illustrated in FIG. 2, for detecting emitted particles, e.g., secondary electrons.

Referring to FIG. 4, if secondary electrons collide with a scintillator 211 coated with a fluorescent material, the secondary electrons stimulate the fluorescent material to emit light that travels along a light guide 212 and then collides with a photocathode disposed at one end of a photomultiplier 215. Since the photocathode is coated with a material for emitting electrons when light collides with the photocathode, photoelectrons emitted from the photocathode enter into photomultiplier 215 for proportionally increasing the number of electrons. A weak voltage generated by photomultiplier 215 is amplified by an amplifier (not shown). An electrical signal (analog signal) obtained in this case is converted into a digital signal by processor 220 illustrated in FIG. 3 and then is image-processed. Also, since a high voltage is required to accelerate the secondary electrons, detection unit 210 further includes a high-voltage connection unit 214 and a high-voltage cable tube 213.

The accelerated electron beam E penetrates into a surface of semiconductor device 190, i.e., a sample, by 1 μm through 5 μm so as to cause an interaction with semiconductor device 190. Secondary electrons are emitted on the surface and thus may follow the shape of the surface well. Since photoelectrons are used as a medium, a bright light is emitted where a large amount of secondary electrons are emitted and a dim light is emitted where only a small amount of secondary electrons are emitted. Accordingly, an image having a contrast is displayed on display screen 230 of the display apparatus illustrated in FIG. 3.

Although FIGS. 2 through 4 are described on the assumption that particles emitted from a sample are secondary electrons, the concept is not limited thereto.

FIG. 5 is a conceptual view showing the types of particles emitted when an electron beam E is irradiated onto a semiconductor device 190 that is a sample.

Referring to FIG. 5, as well as secondary electrons (SE), particles, such as backscattered electrons (BSE), Auger electrons, transmitted electrons, and diffracted electrons, may be emitted. In addition, an X-ray and cathodoluminescent light may be emitted.

That is, although an SEM is mentioned above as an exemplary apparatus using the image forming method illustrated in FIG. 1 if particles emitted from a sample are secondary electrons or backscattered electrons, an Auger electron spectroscope (AES) may use the image forming method illustrated in FIG. 1 if the particles emitted from a sample are Auger electrons. Also, a transmitted electron microscope may use the image forming method illustrated in FIG. 1 if the particles emitted from a sample are transmitted electrons, and an electron probe microanalyzer (EPMA) or an energy dispersive spectroscope (EDS) may use the image forming method illustrated in FIG. 1 if the particles emitted from a sample are X-rays.

FIG. 6 is a conceptual view showing correlations between image frames and an ultimate or final image in the image forming method illustrated in FIG. 1.

Referring to FIG. 6, images 400 and 401 of a semiconductor device, which are displayed on a display screen of a display apparatus, are obtained by integrating a plurality of image frames.

Each of a plurality of image frames 1 through k includes a region of interest image 410 corresponding to a region of interest (see 192 in FIG. 3) of the semiconductor device. Also, each of the image frames 1 through k includes a peripheral region image 411 corresponding to a peripheral region (see 194 in FIG. 3) of the semiconductor device.

According to an order of time, the image frames 1 through k are sequentially aligned. That is, an electron beam is continuously irradiated onto a predetermined place of the semiconductor device, particles emitted from the semiconductor device are sequentially detected and processed according to an order of time, and thus the image frames 1 through k of the semiconductor device are sequentially obtained.

As such, the image frames 1 through k each including region of interest image 410 and peripheral region image 411 respectively corresponding to the region of interest and the peripheral region of the semiconductor device are obtained (operation S120 illustrated in FIG. 1). After that, at least some of the image frames 1 through k (e.g., the image frames 1 through j are selected (operation S130 illustrated in FIG. 1) and then images 400 and 401 of the semiconductor device are obtained by integrating the selected image frames 1 through j (operation S140 illustrated in FIG. 1).

When images 400 and 401 of the semiconductor device are formed, selecting and integrating only some of the image frames 1 through k based on an appropriate standard may be more advantageous than integrating all of the image frames 1 through k, in, for example, size measurement, defect detection, or pattern shape checking.

A standard for selecting the image frames 1 through j from among the image frames 1 through k may be a contrast between region of interest image 410 and peripheral region image 411 in each of the image frames 1 through k.

The contrast between region of interest image 410 and peripheral region image 411 in each of the image frames 1 through k may be measured as a normalized intensity Î that is a ratio of an intensity of particles emitted from the region of interest of the semiconductor device to an intensity of particles emitted from the peripheral region of the semiconductor device, as represented in Equation (1).

$$\hat{I} = \frac{{I}_{1}}{{I}_{2}} \qquad ( 1 )$$

Here, Î is a normalized intensity, I1 is an intensity of particles emitted from a region of interest of a semiconductor device, and I2 is an intensity of particles emitted from a peripheral region of the semiconductor device.

The standard for selecting the image frames 1 through j will now be described in more detail.

FIG. 7 is a flowchart of an operation of selecting at least some image frames (operation S130) in the image forming method illustrated in FIG. 1.

Referring to FIG. 7, at least some of the image frames are selected based on a contrast between a region of interest image and a peripheral region image (operation S130). This includes calculating a normalized intensity Î for each of the image frames (operation S131), and selecting from among the image frames some of all of those image frames having normalized intensities equal to or greater than a threshold constant (operation S134).

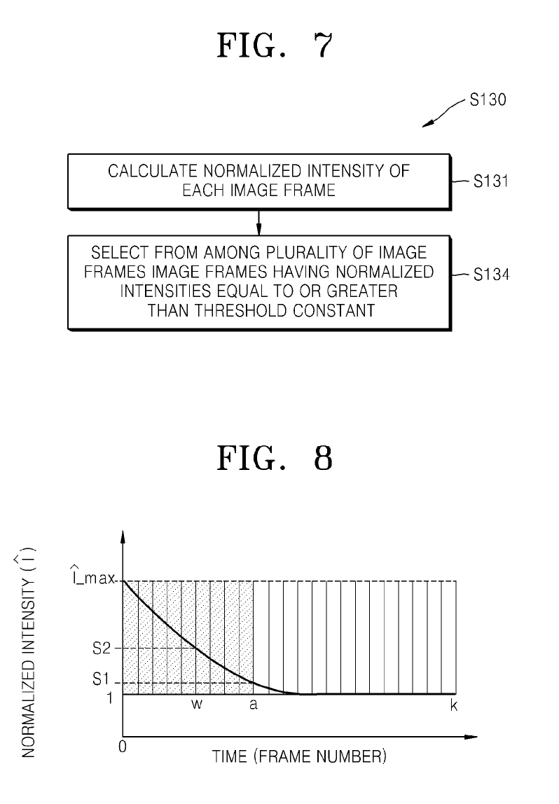

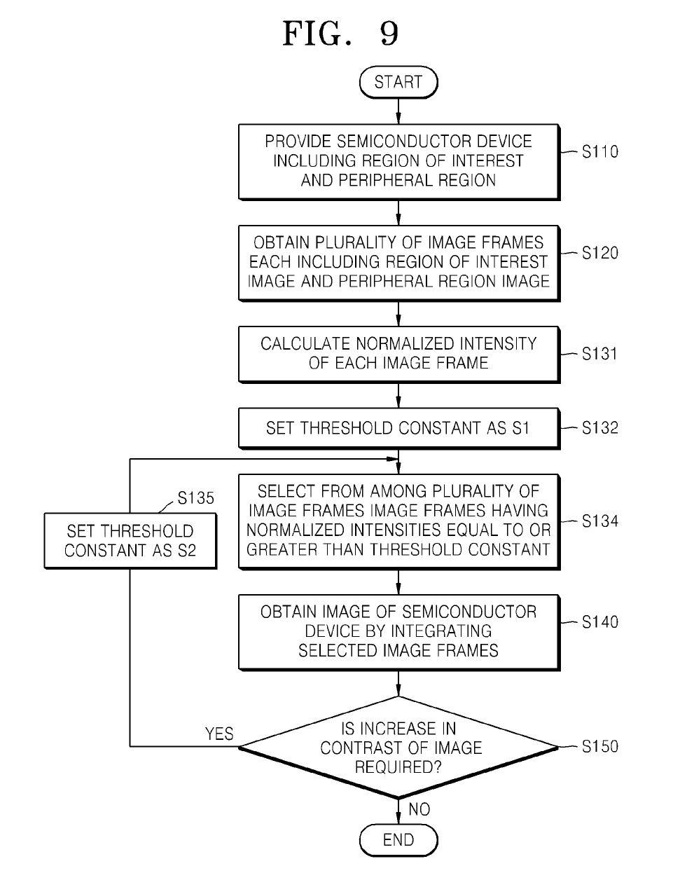

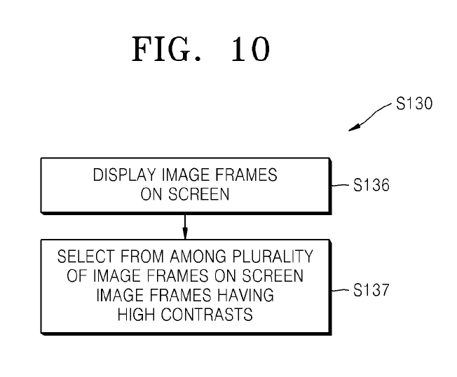

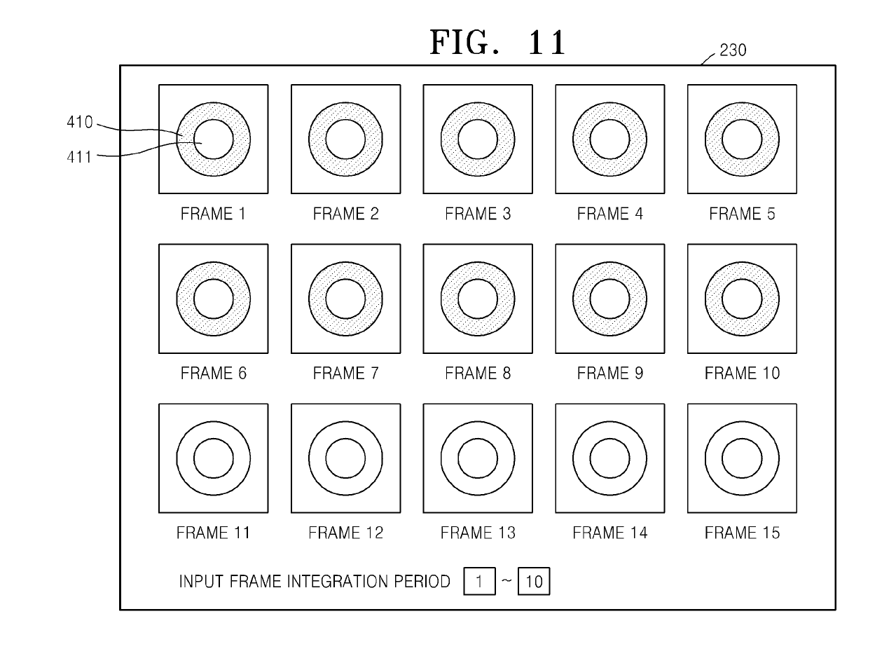

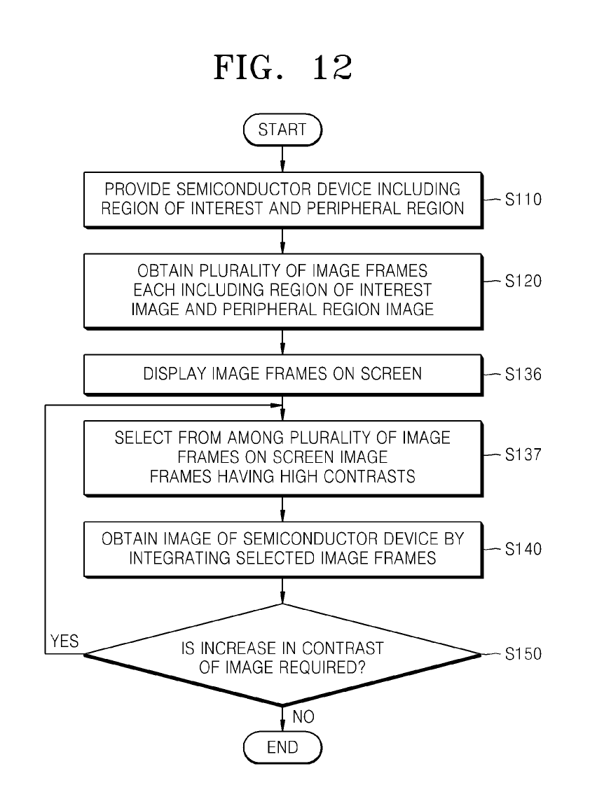

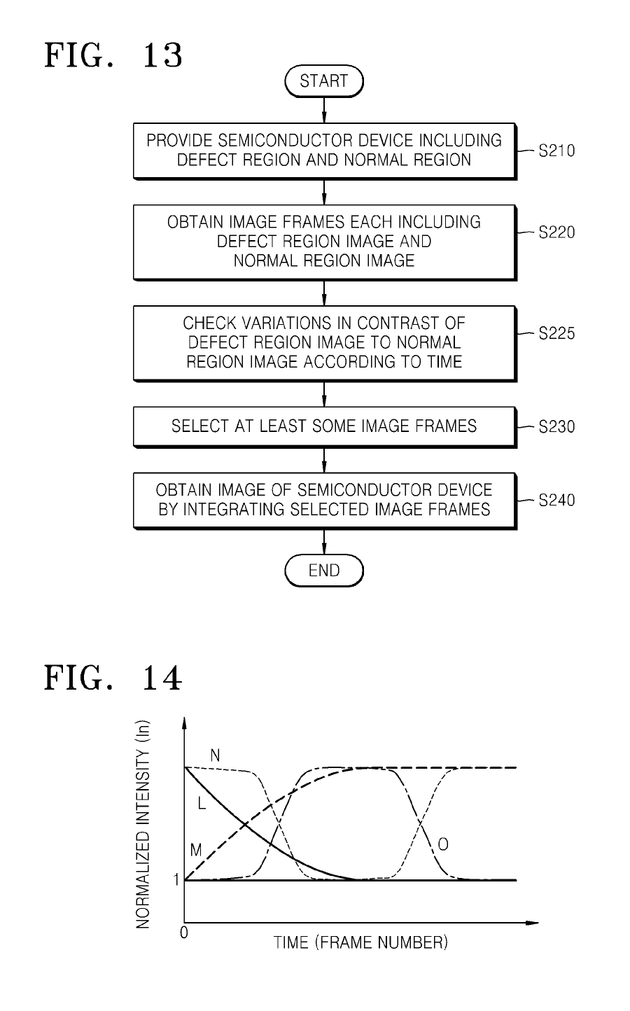

FIG. 8 is a graph showing normalized intensities Î for the image frames 1 through k illustrated in FIG. 6 according to time.

Initially, the normalized intensities Î for the image frames 1 through k are separately calculated. If the image frames 1 through k are aligned according to an order of time on a horizontal axis and the calculated normalized intensities Î for the image frames 1 through k are marked on a vertical axis, variations in normalized intensity according to time are shown.

Referring to FIG. 8, if the image frames 1 through k are aligned according to time, there may be a period in which the normalized intensity Î varies according to time. That is, there may be a period in which a ratio of an intensity of particles emitted from a region of interest to an intensity of particles emitted from a peripheral region varies according to time.

Here, images 400 and 401 of the semiconductor device may be formed by appropriately selecting and integrating some of the image frames 1 through k.

A standard for the selection may be a normalized intensity equal to or greater than a predetermined threshold constant S1. The threshold constant S1 may be β×Î_max, where Î_max is a maximum value from among the normalized intensities according to time and β is a constant greater than 0 and equal to or less than 1.

If the threshold constant is S1, image frames having normalized intensities Î equal to or greater than the threshold constant S1 are the image frames 1 through j. In this case, the image frames 1 through j are integrated to form an ultimate or final image of the semiconductor device.

Image frames having frame numbers greater than j, i.e., the image frames j+1 through k, have normalized intensities less than the threshold constant S1 and thus may reduce a contrast between the region of interest and the peripheral region in the ultimate image of the semiconductor device.

If only image frames having normalized intensities equal to or greater than the threshold constant S1 are selected, an average value of the normalized intensities of the selected image frames is as represented in Equation (2).

$${\hat{I}}_{AVG ( j )} ( x , y ) = \frac{{\sum }_{m = 1}^{j} {\hat{I}}_{m} ( x , y )}{j} \qquad ( 2 )$$

Here, Î_{AVG(j)}(x, y) is an average value of the normalized intensities of the selected image frames at a coordinate (x, y) over the j selected frames, m is a frame number of an image frame from 1 to j, and Îₘ(x, y) is the normalized intensity of image frame m at the coordinate (x, y).

Also, an average value of the normalized intensities of all image frames is as represented in Equation (3).

$${\hat{I}}_{AVG ( k )} ( x , y ) = \frac{{\sum }_{m = 1}^{k} {\hat{I}}_{m} ( x , y )}{k} \qquad ( 3 )$$

Here, Î_{AVG(k)}(x, y) is an average value of the normalized intensities of the selected image frames at a coordinate (x, y) over all k frames

It is clearly shown in FIG. 8 that the average value of the normalized intensities according to Equation (3) is less than the average value of the normalized intensities according to Equation (2).

Accordingly, it is checked that selecting and integrating some of the image frames 1 through k, i.e., the image frames 1 through j, is more advantageous than integrating all of the image frames 1 through k, in increasing a contrast between an image corresponding and a region of interest and an image corresponding to a peripheral region in an ultimate or final image of a semiconductor device.

In addition, in order to increase the contrast between the image corresponding to the region of interest and the image corresponding to the peripheral region in the ultimate or final image of the semiconductor device, an increase in value of a threshold constant, i.e., a standard for selecting image frames, may be required.

For example, the threshold constant may be set as S2, which is greater than S1. The threshold constant S2 may be γ×Î_max, where Î_max is a maximum value from among the normalized intensities according to time and γ may be greater than β and equal to or less than 1. In this case, an average value of normalized intensities of image frames selected and having normalized intensities equal to or greater than the threshold constant S2 is as represented in Equation (4).

$${\hat{I}}_{AVG ( w )} ( x , y ) = \frac{{\sum }_{m = 1}^{w} {\hat{I}}_{m} ( x , y )}{w} \qquad ( 4 )$$

Since the image frames 1 through w are selected and integrated to obtain the ultimate or final image of the semiconductor device, the number of selected image frames is less than that in a case when the threshold constant is S1 but the contrast between the image corresponding to the region of interest and the image corresponding to the peripheral region in the ultimate or final image of the semiconductor device may be increased.

FIG. 9 is a flowchart of a method of forming an image of a semiconductor device, to which the concept of FIG. 7 is reflected.

Referring to FIG. 9, a semiconductor device including a region of interest and a peripheral region is provided (operation S110), and a plurality of image frames each including a region of interest image and a peripheral region image respectively corresponding to the region of interest and the peripheral region of the semiconductor device are obtained (operation S120).

Then, normalized intensities of the image frames are calculated (operation S131), a threshold constant is set as S1 (operation S132), and then at least some of the image frames, which have normalized intensities equal to or greater than the threshold constant, are selected (operation S134).

Then, an image of the semiconductor device is obtained by integrating the selected image frames (operation S140), and it is determined whether an increase in the contrast of the image of the semiconductor device is required (operation S150).

If it is determined that an increase in the contrast of the image of the semiconductor device is not required, the image forming method is terminated and the image of the semiconductor device, which is obtained in operation S140, is displayed as an ultimate or final image. Otherwise, if it is determined that an increase in the contrast of the image of the semiconductor device is required, the threshold constant is reset as S2, which is greater than S1, and then operations S134, S140, and S150 are re-performed by using the reset threshold constant S2.

If it is determined that an increase in the contrast of the image of the semiconductor device is further required, it will be clearly understood that the threshold constant is continuously increased and then operations S134, S140, and S150 are re-performed.

From among the above-described operations, the obtaining of the image frames (operation S120), the calculating of the normalized intensities (operation S131), the setting of the threshold constant (operations S132 and S135), the selecting of at least some of the image frames (operation S134), and the obtaining of the image of the semiconductor device by integrating the selected image frames (operation S140) may be automatically performed by processor 220 illustrated in FIG. 2.

Accordingly, the image of the semiconductor device may be formed within a much shorter time in comparison to a case when a user manually performs the operations.

However, referring to FIG. 10, the selecting of at least some of the image frames (operation S130 illustrated in FIG. 1) may be manually performed by a user without using processor 220.

That is, the selecting of at least some of the image frames (operation S130 illustrated in FIG. 1) may include displaying the obtained image frames on a display screen of a display apparatus (operation S136), and arbitrarily selecting, by a user, some of the image frames having high contrasts between a region of interest image and a peripheral region image on the display screen (operation S137).

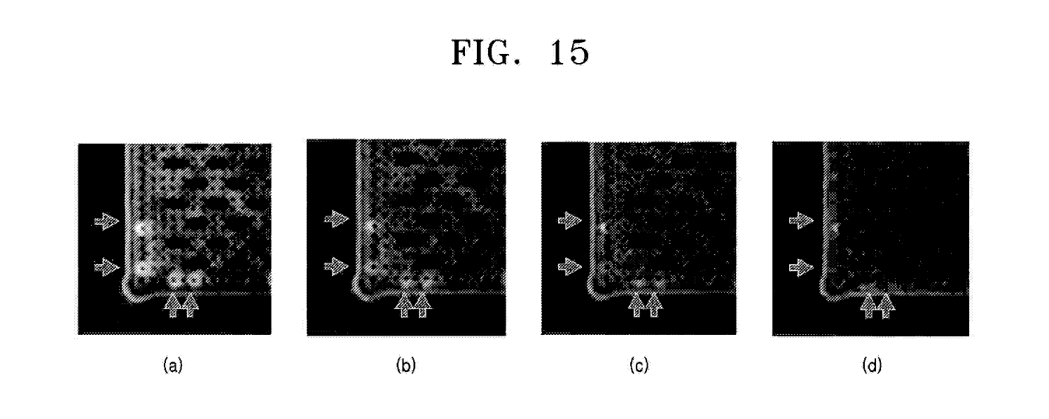

FIG. 11 is a diagram showing alignment of exemplarily image frames 1 through 15 on display screen 230 of the display apparatus, for describing operations S136 and S137 illustrated in FIG. 10.

Referring to FIG. 11, the aligned image frames 1 through 15 are the image frames described above in relation to FIGS. 6 and 8. In particular, it is exemplarily assumed that frame numbers j and k in FIGS. 6 and 8 are frame numbers 10 and 15 in FIG. 11, respectively.

A user may check with their bare eyes the contrast between region of interest image 410 and peripheral region image 411 in each of the image frames 1 through 15 aligned according to an order of time on display screen 230 of the display apparatus. As illustrated in FIG. 8, the contrast is gradually decreased from the image frame 1 to the image frame 10 and is maintained at a very low level from the image frame 11 to the image frame 15.

In this case, in order to optimize the contrast between an image corresponding to a region of interest and an image corresponding to a peripheral region in an ultimate or final image of a semiconductor device, the user may form the ultimate or final image of the semiconductor device by selecting and integrating only the image frames 1 through 10. Also, the user may form the ultimate or final image of the semiconductor device by directly inputting on screen 230 a frame integration period, i.e., frame numbers of the selected image frames.

If it is determined that an increase in the contrast of the image obtained by selecting and integrating the image frames 1 through 10 is further required, the user may reset the frame integration period.

FIG. 12 is a flowchart of a method of forming an image of a semiconductor device, to which the concept of FIG. 10 is reflected.

Referring to FIG. 12, initially, a semiconductor device including a region of interest and a peripheral region is provided (operation S110), and a plurality of image frames each including a region of interest image and a peripheral region image respectively corresponding to the region of interest and the peripheral region are obtained (operation S120).

Then, the obtained image frames are displayed on a display screen of a display apparatus (operation S136), and at least some of the image frames, in which the contrast between the region of interest image and the peripheral region image is high, are arbitrarily selected on the display screen by a user (operation S137).

Then, an image of the semiconductor device is obtained by integrating the selected image frames (operation S140), and it is determined whether an increase in the contrast of the image of the semiconductor device is required (operation S150).

If it is determined that an increase in contrast of the image of the semiconductor device is not required, the image forming method is terminated and the image of the semiconductor device, which is obtained in operation S140, is displayed as an ultimate or final image. Otherwise, if it is determined that an increase in contrast of the image of the semiconductor device is required, the user arbitrarily re-selects image frames on the display screen (operation S137) and then operations S140 and S150 are re-performed.

If the ultimate or final image of the semiconductor device is formed by arbitrarily selecting, by the user, image frames on the display screen of the display apparatus as described above, although an image forming speed is rather reduced in comparison to a case when a calculation apparatus automatically selects image frames, an image contrast having a plurality of variables in addition to a threshold constant may be finely adjusted and an increase in image contrast may be flexibly performed by using a trial-and-error method.

A method of forming an image of a semiconductor device is described above. The method may be used for various purposes, for example, to detect a defect of the semiconductor device.

Accordingly, a method of detecting a defect of a semiconductor device, which employs a method of forming an image of a semiconductor device is described above, will now be described in detail.

FIG. 13 is a flowchart of a method of detecting a defect of a semiconductor device.

Referring to FIG. 13, the defect detecting method includes providing a semiconductor device including a defect region and a normal region (operation S210), obtaining a plurality of image frames each including a defect region image and a normal region image respectively corresponding to the defect region and the normal region of the semiconductor device (operation S220), checking variations in the contrast between the defect region image and the normal region image according to time in the image frames (operation S225), selecting at least some of the image frames based on the contrast between the defect region image and the normal region image (operation S230), and obtaining an ultimate or final image of the semiconductor device by integrating the selected image frames (operation S240).

The defect region and the normal region in the above-mentioned operations respectively correspond to the region of interest and the peripheral region of the semiconductor device which are described in the image forming method above.

Accordingly, the descriptions of a region of interest (see 192 in FIG. 3) and a peripheral region (see 194 in FIG. 3) on a semiconductor device, which are provided in the image forming method, may also correspondingly apply to a defect region and a normal region on a semiconductor device in the defect detecting method.

Also, the descriptions of a region of interest image (see 410 in FIGS. 6 and 11) and a peripheral region image (see 411 in FIGS. 6 and 11) of an image frame, which are provided above in the description of an image forming method, may also correspondingly apply to a defect region image and a normal region image of an image frame in the defect detecting method.

Furthermore, the descriptions of an image corresponding to a region of interest (see 400 in FIG. 3) and an image corresponding to a peripheral region (see 401 in FIG. 3) for forming an ultimate or final image of a semiconductor device, which are provided in the image forming method, may also correspondingly apply to an image corresponding to a defect region and an image corresponding to a normal region in the defect detecting method for forming an ultimate or final image of a semiconductor device.

Also, some operations S210, S220, S230, and S240 illustrated in FIG. 13 respectively correspond to operations S110, S120, S130, and S140 illustrated in FIG. 1, and thus repeated descriptions thereof will not be provided here.

Here, the checking of variations in the contrast between the defect region image and the normal region image according to time in the image frames (operation S225) will be described.

FIG. 14 is a graph showing representative variations in the contrast between a defect region image and a normal region image according to time.

Referring to FIG. 14, there may be a first case wherein the contrast (for example, a normalized intensity) between a defect region image and a normal region image is greater in an early period than in a late period (graph L), a second case wherein the contrast (for example, the normalized intensity) between the defect region image and the normal region image is greater in a late period than in an early period (graph M), a third case wherein the contrast (for example, the normalized intensity) between the defect region image and the normal region image is greater in an early period and a late period than in a middle period (graph N), and a fourth case wherein the contrast (for example, the normalized intensity) between the defect region image and the normal region image is greater in a middle period than in an early period and a late period (graph O).

Here, time periods of obtained image frames include an early period and a late period in graph L and graph M, and the early period, a middle period, and the late period in graph N and graph O.

The checking of variations in contrast according to time may be an operation that has to be performed first to select some image frames.

FIG. 15 illustrates sequential SEM images (a) through (d) showing variations in contrast of a defect region image to a normal region image according to time.

Referring to FIG. 15, in an early period, a defect region image (indicated by arrows) is brighter than a normal region image and is checked due to a high contrast (image (a)). However, as time passes, the defect region image gradually becomes darker and, ultimately, is hardly distinguished from the normal region image in contrast (image (d)).

Such variations in contrast correspond to a case when the contrast is greater in the early period than in a late period (graph L in FIG. 14). In this case, it is advantageous to obtain an ultimate or final image of a semiconductor device by selecting image frames in the early period, ensuring the contrast between the defect region image and the normal region image.

The variations in contrast between the defect region image and the normal region image according to time occur because the amount of charges of an electron beam irradiated onto a surface of the semiconductor device, i.e., a sample, are not the same as the amount of charges of particles emitted from the surface of the semiconductor device, and thus the surface of the semiconductor device is electrified with charges. In this case, since a degree of electrification varies according to time, the contrast between the defect region image and the normal region image varies in units of image frames.

FIGS. 16 and 17 are cross-sectional views of a semiconductor device of which a defect is to be detected by forming an image of the semiconductor device. These cross-sectional views are exemplarily illustrated to describe the reason for variations in contrast between a defect region image and a normal region image according to time.

Referring to FIG. 16, an active region AR defined by an inactive region FR is provided on a semiconductor substrate 420, e.g., a silicon substrate. The inactive region FR is formed by burying an insulating layer in trenches 422 prepared by etching semiconductor substrate 420. A plurality of gate stacks 434 functioning as word lines are formed on semiconductor substrate 420 on which the active region AR is defined. Each of gate stacks 434 includes a gate insulating layer 426, a gate electrode 428, a gate cap layer 430, and a gate spacer 432. Impurities regions, i.e., source and drain regions 436 and 438, are formed under side walls of gate stacks 434. Contact pads 440 and 442 are formed on semiconductor substrate 420 between gate spacers 432. Contact pads 440 and 442 are formed between gate stacks 434 on source and drain regions 436 and 438. Contact pads 440 and 442 are insulated from each other by an interlayer insulating layer 439. Contact pads 440 and 442 may be formed as an impurity-doped polysilicon layer, including direct contact (DC) pads 442 and buried contact (BC) pads 440. A bit line and a capacitor are respectively connected to DC and BC pads 442 and 440.

In this semiconductor device, a defect region in which, for example, DC and BC pads 440 and 442 are not normally formed may be detected by using an SEM. That is, DC pads 442 may include a normal region N electrically connected to drain region 438 and a defect region D not electrically connected to drain region 438.

Secondary electrons SED emitted from a surface of the semiconductor device when an electron beam E is irradiated onto the defect region D may vary according to time more greatly than secondary electrons SEN emitted from the surface when the electron beam E is irradiated onto the normal region N, because the defect region D has an isolated structure in comparison to the normal region N and thus has greater variations in electrification according to time.

Referring to FIG. 17, a trench pattern T is formed in an upper surface of a semiconductor substrate 421 that is a sample. In a normal region N, the trench pattern T is formed to a predetermined depth. On the other hand, in a defect region D, the trench pattern T is not formed to the predetermined depth and may be partially formed.

When this sample is inspected by using an SEM, since an intensity of secondary electrons SEN emitted when an electron beam E is irradiated onto the normal region N is different from an intensity of secondary electrons SED emitted when the electron beam E is irradiated onto the defect region D, an image that may be checked on a display screen of a display apparatus may be obtained.

However, since a conductor structure is not formed on a surface of the sample, the variations in contrast between a defect region image and a normal region image according to time, illustrated in FIG. 15, may not occur. That is, the defect detecting method illustrated in FIG. 13 may be more effective when a conductor structure is formed on a surface of a semiconductor device that is a sample.

The defect detecting method in some representative cases when a contrast between a defect region image and a normal region image varies according to time (see FIG. 14) will now be described in detail.

FIG. 18 is a flowchart of a method of detecting a defect of a semiconductor device in a case when the contrast (for example, the normalized intensity) between a defect region image and a normal region image is greater in an early period than in a late period (graph L in FIG. 14).

Referring to FIG. 18, checking that variations in the normalized intensity of image frames according to time are greater in the early period than in the late period (operation S226), and selecting of image frames corresponding to the early period (operation S236) are different from the defect detecting method illustrated in FIG. 13, and are already described above in relation to FIGS. 6, 8, and 11.

Also, some operations S210, S220, and S240 illustrated in FIG. 18 respectively correspond to operations S210, S220, and S240 illustrated in FIG. 13, and thus repeated descriptions thereof will not be provided here.

FIG. 19 is a flowchart of a method of detecting a defect of a semiconductor device in a case when the contrast (for example, the normalized intensity) between a defect region image and a normal region image is greater in a late period than in an early period (graph M in FIG. 14).

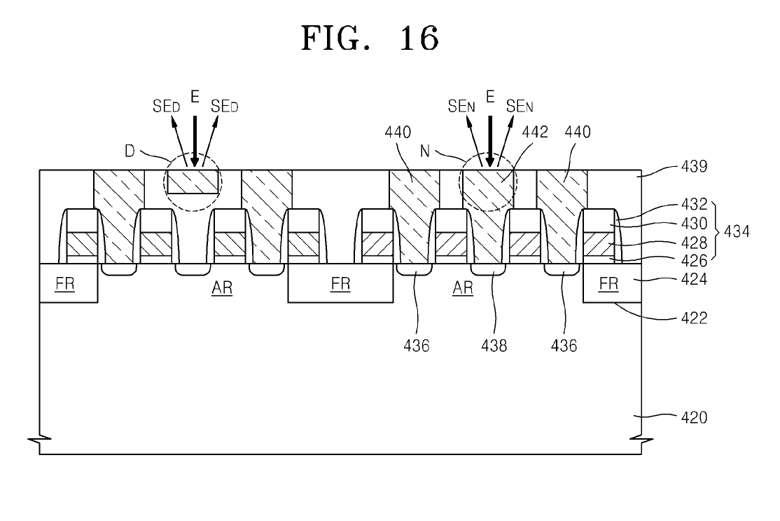

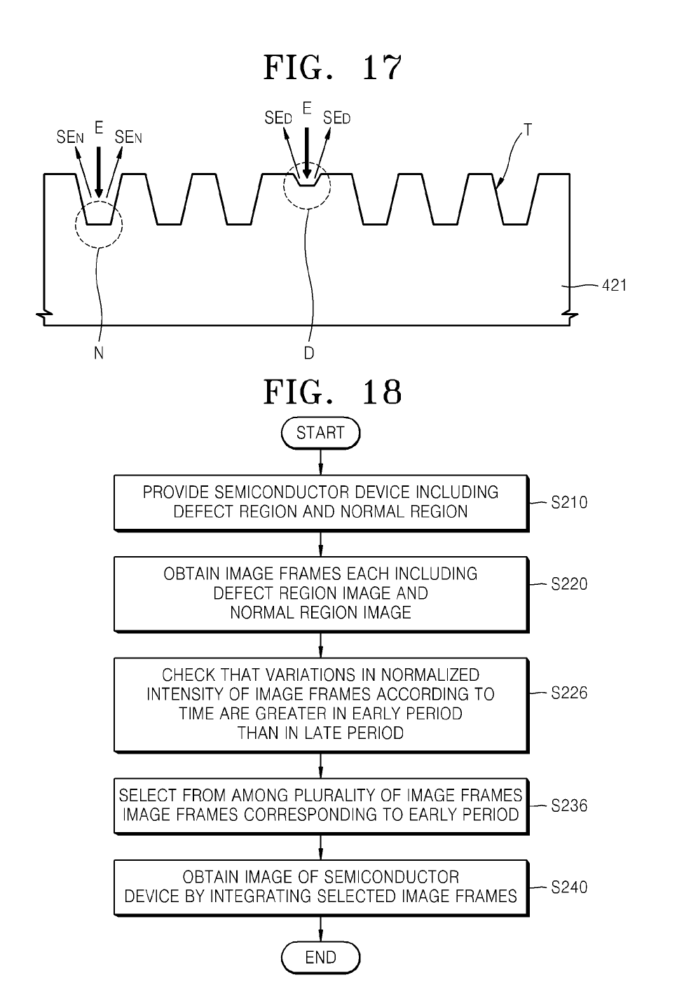

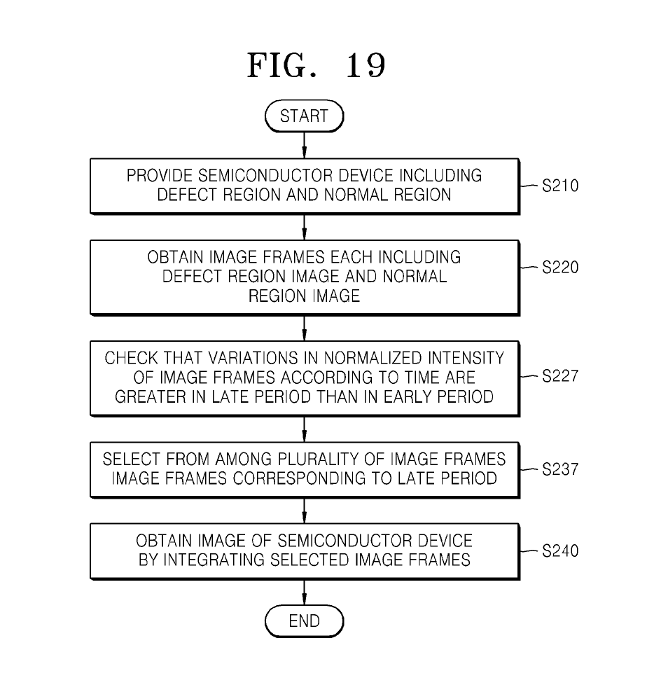

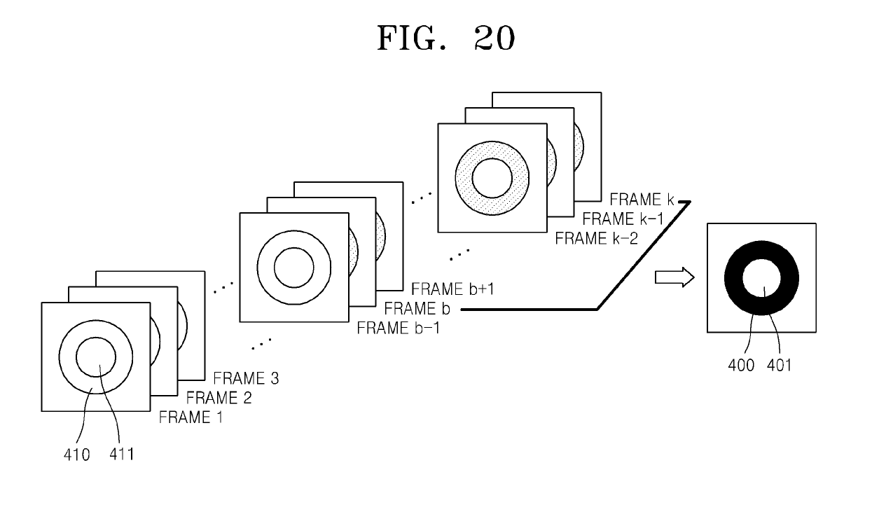

Referring to FIG. 19, checking that variations in the normalized intensity of image frames according to time are greater in the late period than in the early period (operation S227), and selecting of image frames corresponding to the late period (operation S237) are different from the defect detecting method illustrated in FIG. 13, and will now be described in detail with reference to FIGS. 20 through 22.

Referring to FIG. 20, a plurality of image frames 1 through k each including defect region image 410 and normal region image 411 are obtained (operation S220), the image frames b through k corresponding to the late period are selected from among the image frames 1 through k (operation S237), and images 400 and 401 of a semiconductor device are obtained by integrating the selected image frames b through k (operation S240).

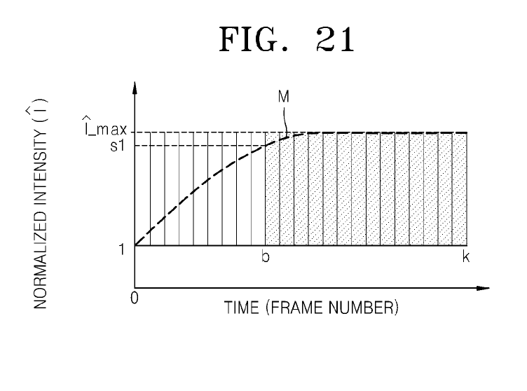

Referring to FIG. 21, variations in the normalized intensity of image frames according to an order of time occur, and it is checked that the variations in normalized intensity of image frames according to time are greater in the late period than in the early period (operation S227). Also, the image frames b through k corresponding to the late period are selected from among the image frames 1 through k (operation S237) based on normalized intensities equal to or greater than a threshold constant S1. An average value of the normalized intensities of the selected image frames b through k is as represented in Equation (5).

$${\hat{I}}_{AVG ( b - k )} ( x , y ) = \frac{{\sum }_{m = b}^{k} {\hat{I}}_{m} ( x , y )}{k - b + 1} \qquad ( 5 )$$

Since the average value of the normalized intensities according to Equation (5) is greater than that according to Equation (3), an ultimate or final image of a semiconductor device, which is obtained by integrating the selected image frames b through k, has a greater contrast between a defect region image and a normal region image than an ultimate or final image of a semiconductor device which is obtained by integrating all of the image frames 1 through k.

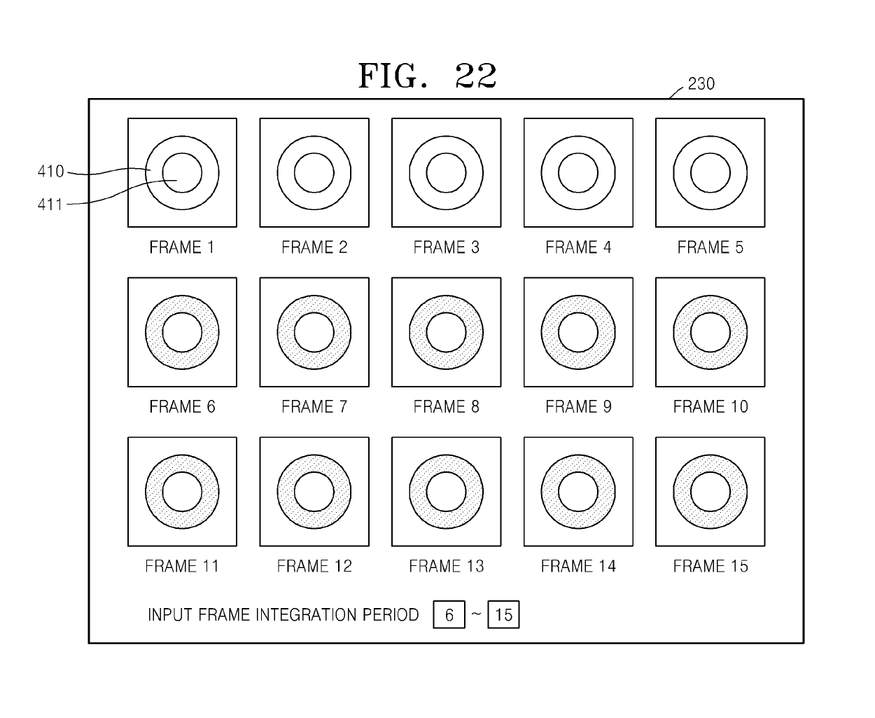

Referring to FIG. 22, image frames 6 through 15 corresponding to the late period are selected from among a plurality of image frames 1 through 15 (operation S237).

The aligned image frames 1 through 15 are the image frames described above in relation to FIGS. 20 and 21. In particular, it is exemplarily assumed that frame numbers b and k in FIGS. 20 and 21 are frame numbers 6 and 15 in FIG. 22, respectively.

A user may check with their bare eyes the contrast between region of interest image 410 and peripheral region image 411 in each of the image frames 1 through 15 aligned according to an order of time on display screen 230 of the display apparatus. As illustrated in FIG. 21, the contrast is gradually increased from the image frame 1 to the image frame 5 and is maintained at a level higher than a threshold constant S1 from the image frame 6 to the image frame 15.

In this case, in order to optimize the contrast between an image corresponding to a region of interest and an image corresponding to a peripheral region in an ultimate or final image of a semiconductor device, the user may form the ultimate or final image of the semiconductor device by selecting and integrating only the image frames 6 through 15. Also, the user may form the ultimate or final image of the semiconductor device by directly inputting on screen 230 a frame integration period, i.e., frame numbers of the selected image frames. If it is determined that an increase in the contrast of the image obtained by selecting and integrating the image frames 6 through 15 is further required, the user may reset the frame integration period.

FIG. 23 is a flowchart of a method of detecting a defect of a semiconductor device in a case when the contrast (for example, the normalized intensity) between a defect region image and a normal region image is greater in an early period and a late period than in a middle period (graph N in FIG. 14).

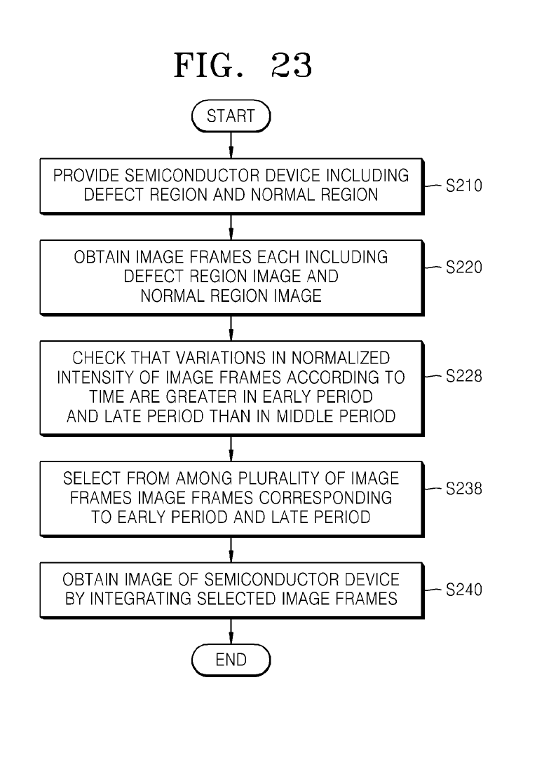

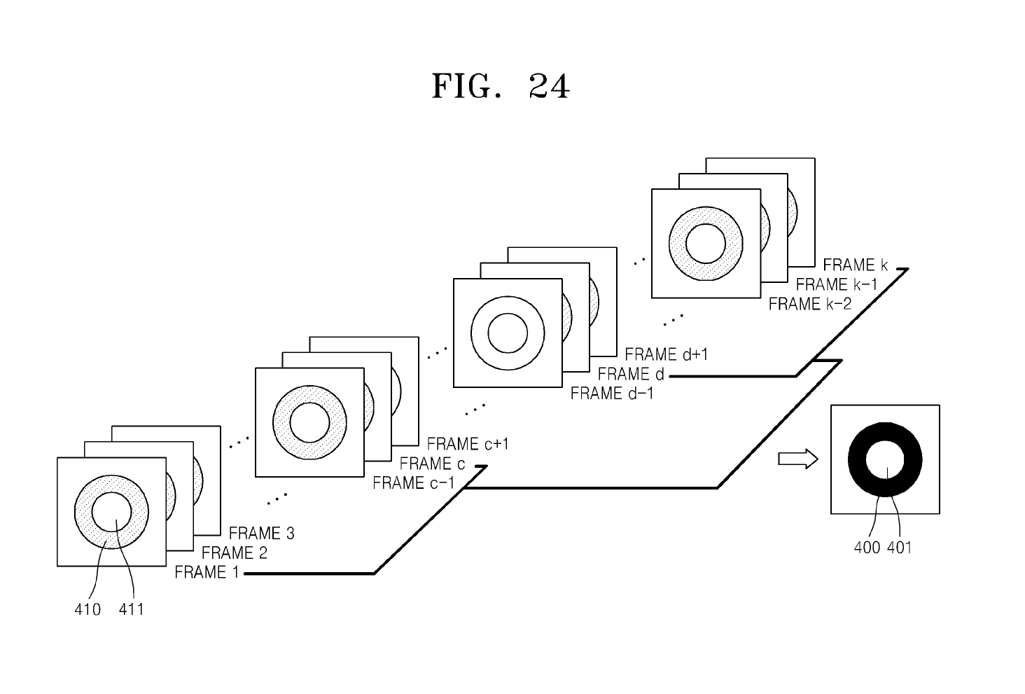

Referring to FIG. 23, checking that variations in the normalized intensity of image frames according to time are greater in the early period and the late period than in the middle period (operation S228), and selecting of image frames corresponding to the early period and the late period (operation S238) are different from the defect detecting method illustrated in FIG. 13, and will now be described in detail with reference to FIGS. 24 through 26.

Referring to FIG. 24, a plurality of image frames 1 through k each including defect region image 410 and normal region image 411 are obtained (operation S220), the image frames 1 through c corresponding to the early period and the image frames d through k corresponding to the late period are selected from among the image frames 1 through k (operation S238), and images 400 and 401 of a semiconductor device are obtained by integrating the selected image frames 1 through c, and d through k (operation S240).

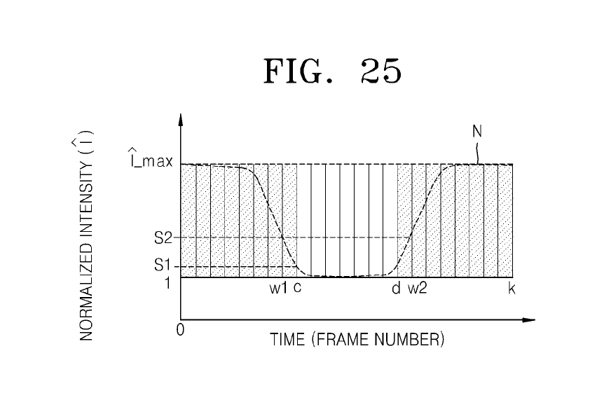

Referring to FIG. 25, variations in the normalized intensity of image frames according to an order of time occur, and it is checked that the variations in the normalized intensity of image frames according to time are greater in the early period and the late period than in the middle period (operation S228).

Also, the image frames 1 through c corresponding to the early period and the image frames d through k corresponding to the late period are selected from among the image frames 1 through k (operation S238) based on normalized intensities equal to or greater than a threshold constant S1.

An average value of the normalized intensities of the selected image frames 1 through c, and d through k is as represented in Equation (6).

$${\hat{I}}_{AVG ( 1 - c , d - k )} ( x , y ) = \frac{{\sum }_{m = 1}^{c} {\hat{I}}_{m} ( x , y ) + {\sum }_{m = d}^{k} {\hat{I}}_{m} ( x , y )}{c + ( k - d ) + 1} \qquad ( 6 )$$

Since the average value of the normalized intensities according to Equation (6) is greater than that according to Equation (3), an ultimate or final image of a semiconductor device, which is obtained by integrating the selected image frames 1 through c, and d through k, has a greater contrast between a defect region image and a normal region image than an ultimate or final image of a semiconductor device which is obtained by integrating all of the image frames 1 through k.

Also, if the threshold constant is S1 and it is determined that an increase in the contrast of the ultimate image of the semiconductor device is further required, the threshold constant may be reset as S2, which is greater than S1, and the ultimate or final image of the semiconductor device may be obtained by re-selecting image frames.

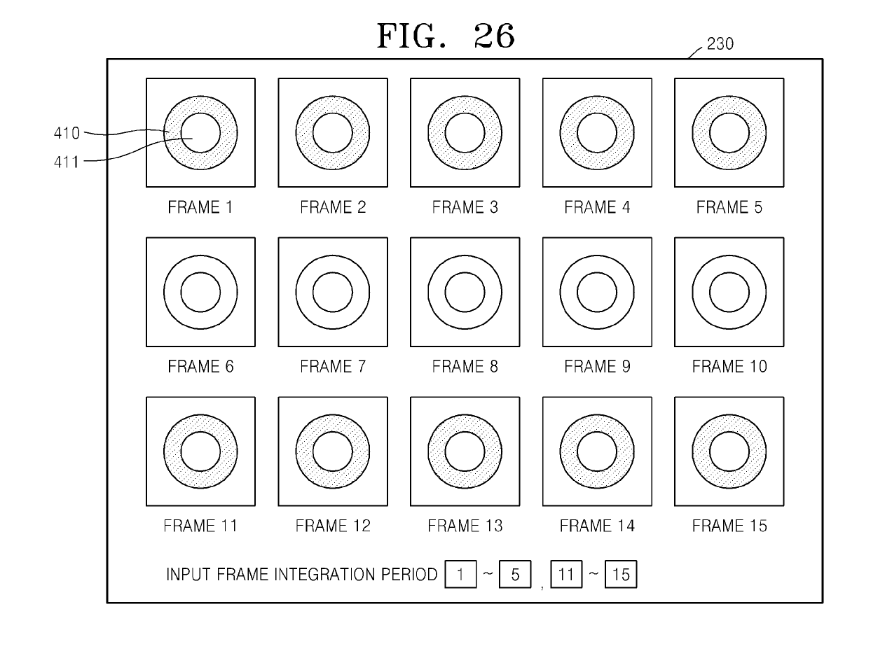

Referring to FIG. 26, image frames 1 through 5 corresponding to the early period and image frames 11 through 15 corresponding to the late period are selected from among a plurality of image frames 1 through 15 (operation S238).

The aligned image frames 1 through 15 are the image frames described above in relation to FIGS. 24 and 25. In particular, it is exemplarily assumed that frame numbers c, d, and k in FIGS. 24 and 25 are frame numbers 5, 11, and 15 in FIG. 26, respectively.

A user may check with their bare eyes a contrast of a region of interest image 410 to a peripheral region image 411 in each of the image frames 1 through 15 aligned according to an order of time on display screen 230 of the display apparatus. As illustrated in FIG. 25, the contrast is relatively high from the image frame 1 to the image frame 5 and is also relatively high from the image frame 11 to the image frame 15.

In this case, in order to optimize the contrast between an image corresponding to a region of interest and an image corresponding to a peripheral region in an ultimate or final image of a semiconductor device, the user may form the ultimate or final image of the semiconductor device by selecting and integrating only the image frames 1 through 5, and 11 through 15. Also, the user may form the ultimate or final image of the semiconductor device by directly inputting on display screen 230 a frame integration period, i.e., frame numbers of the selected image frames. If it is determined that an increase in the contrast of the image obtained by selecting and integrating the image frames 1 through 5, and 11 through 15 is further required, the user may reset the frame integration period.

FIG. 27 is a flowchart of a method of detecting a defect of a semiconductor device in a case when the contrast (for example, the normalized intensity) between a defect region image and a normal region image is greater in a middle period than in an early period and a late period (graph O in FIG. 14).

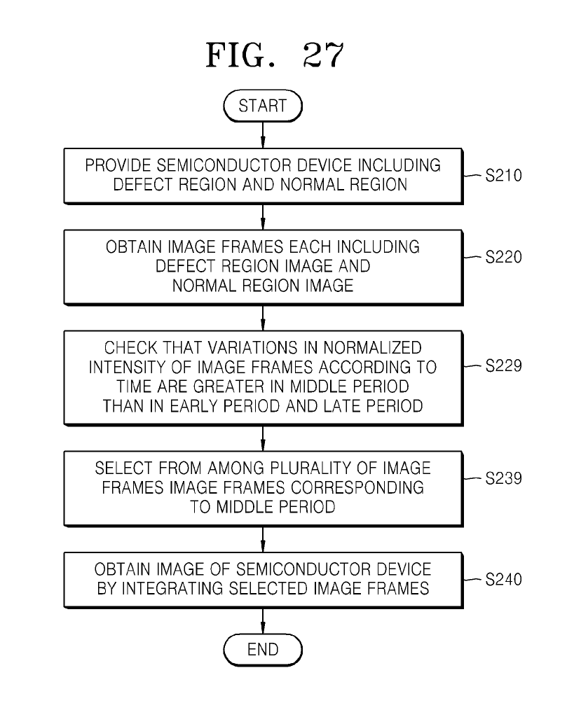

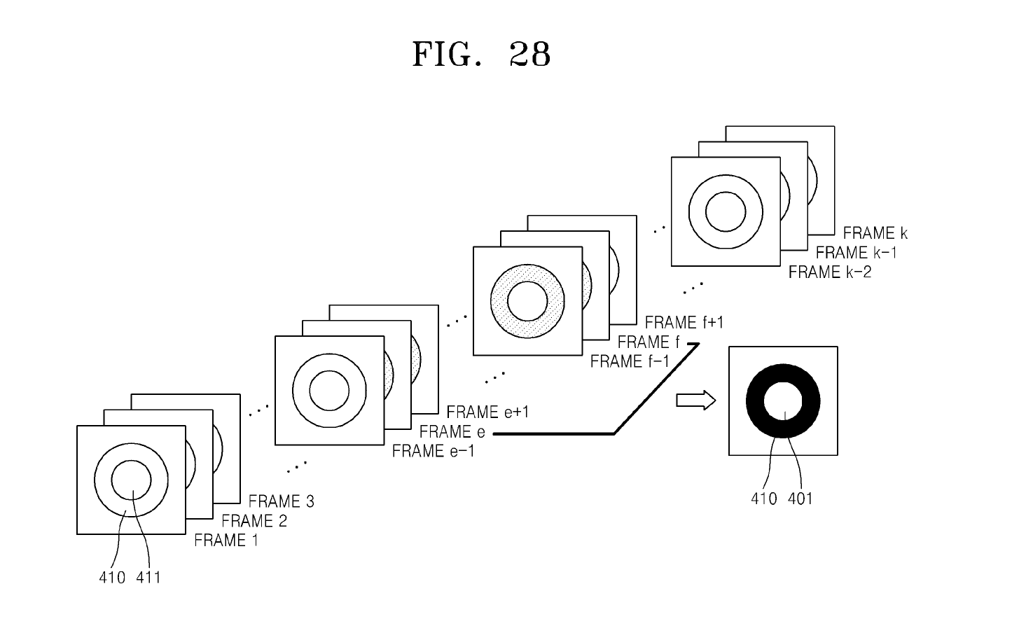

Referring to FIG. 27, checking that variations in the normalized intensity of image frames according to time are greater in the middle period than in the early period and the late period (operation S229), and selecting of image frames corresponding to the middle period (operation S239) are different from the defect detecting method illustrated in FIG. 13, and will now be described in detail with reference to FIGS. 28 through 30.

Referring to FIG. 28, a plurality of image frames 1 through k each including a defect region image 410 and normal region image 411 are obtained (operation S220), the image frames e through f corresponding to the middle period are selected from among the image frames 1 through k (operation S239), and images 400 and 401 of a semiconductor device are obtained by integrating the selected image frames e through f (operation S240).

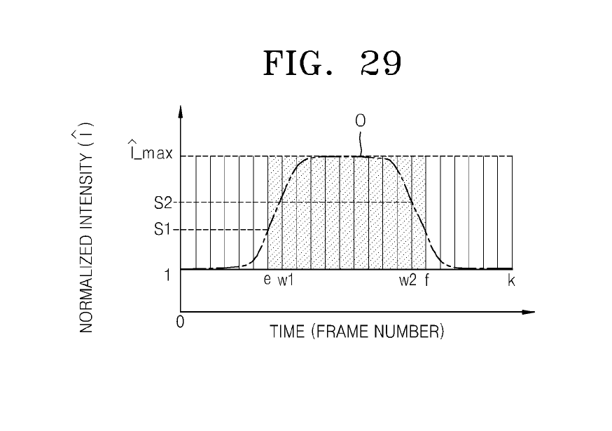

Referring to FIG. 29, variations in the normalized intensity of image frames according to an order of time occur, and it is checked that the variations in normalized intensity of image frames according to time are greater in the middle period than in the early period and the late period (operation S229).

Also, the image frames e through f corresponding to the middle period are selected from among the image frames 1 through k (operation S239) based on normalized intensities equal to or greater than a threshold constant S1.

An average value of the normalized intensities of the selected image frames e through f is as represented in Equation (7).

$${\hat{I}}_{AVG ( e - f )} ( x , y ) = \frac{{\sum }_{m = e}^{f} {\hat{I}}_{m} ( x , y )}{f - e + 1} \qquad ( 7 )$$

Since the average value of the normalized intensities according to Equation (7) is greater than that according to Equation (3), an ultimate or final image of a semiconductor device, which is obtained by integrating the selected image frames e through f, has a greater contrast between a defect region image and a normal region image then an ultimate or final image of a semiconductor device which is obtained by integrating all of the image frames 1 through k.

Also, if the threshold constant is S1 and it is determined that an increase in contrast of the ultimate or final image of the semiconductor device is further required, the threshold constant may be reset as S2, which is greater than S1, and the ultimate or final image of the semiconductor device may be obtained by re-selecting image frames.

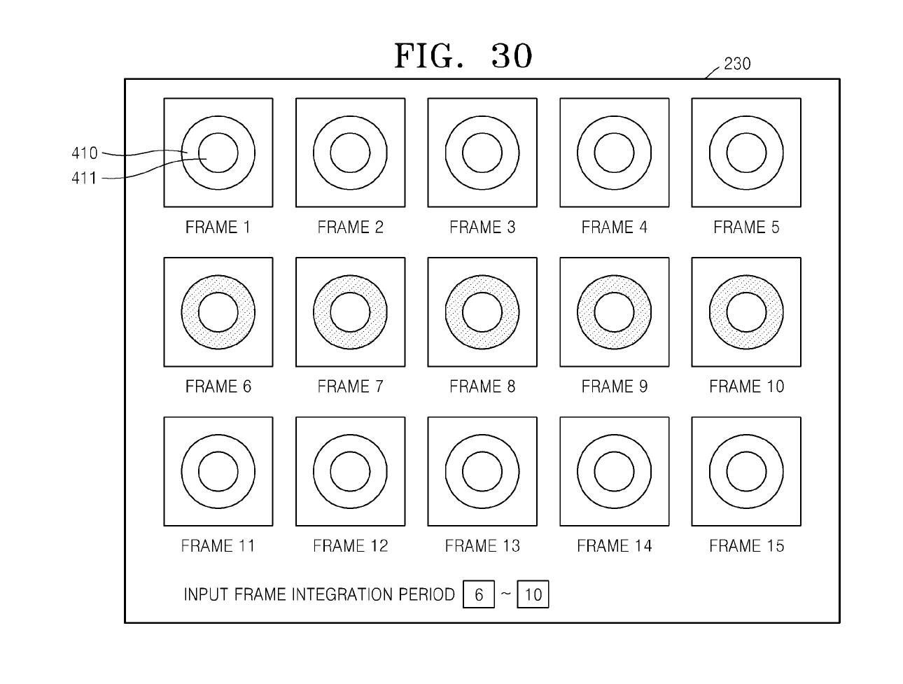

Referring to FIG. 30, image frames 6 through 10 corresponding to the middle period are selected from among a plurality of image frames 1 through 15 (operation S239).

The aligned image frames 1 through 15 are the image frames described above in relation to FIGS. 28 and 29. In particular, it is exemplarily assumed that frame numbers e, f, and k in FIGS. 28 and 29 are frame numbers 6, 10, and 15 in FIG. 30, respectively.

A user may check with their bare eyes the contrast between a region of interest image 410 and a peripheral region image 411 in each of the image frames 1 through 15 aligned according to an order of time on display screen 230 of the display apparatus. As illustrated in FIG. 29, the contrast is relatively high from the image frame 6 to the image frame 10.

In this case, in order to optimize the contrast between an image corresponding to a region of interest and an image corresponding to a peripheral region in an ultimate or final image of a semiconductor device, the user may form the ultimate or final image of the semiconductor device by selecting and integrating only the image frames 6 through 10. Also, the user may form the ultimate or final image of the semiconductor device by directly inputting on display screen 230 a frame integration period, i.e., frame numbers of the selected image frames. If it is determined that an increase in the contrast of the image obtained by selecting and integrating the image frames 6 through 10 is further required, the user may reset the frame integration period.

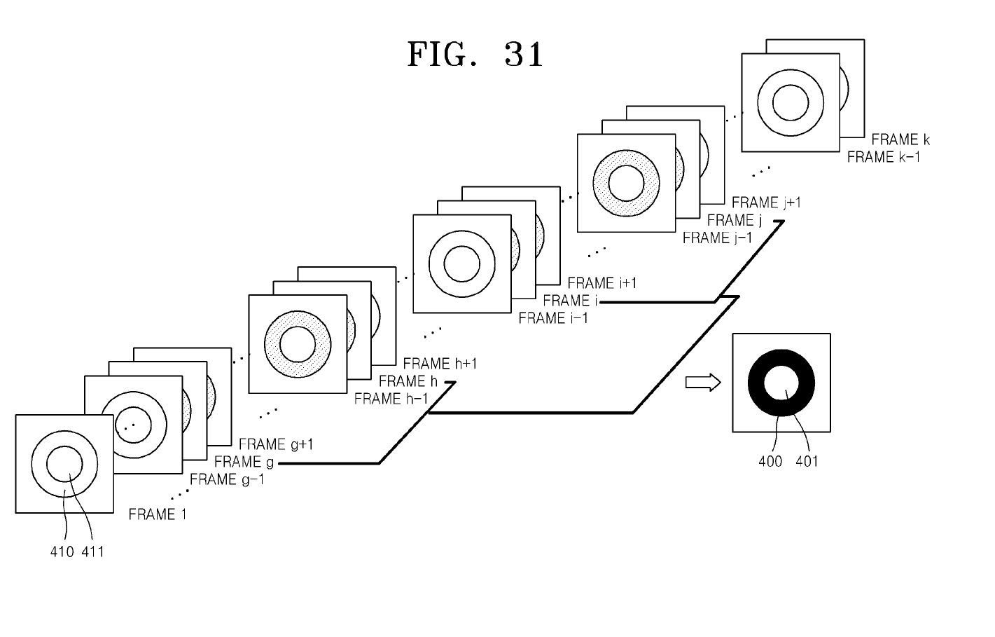

Four representative types of variations in normalized intensity of image frames according to time are described above in relation to FIGS. 18 through 30. However, in some cases, indeterminate types of variations may occur. Obtaining of a plurality of image frames each including a defect region image and a normal region image respectively corresponding to a defect region and a normal region of a semiconductor device (operation S220), selecting of at least some of the image frames based on the contrast between the defect region image and the normal region image (operation S230), and obtaining of an image of a semiconductor device by integrating the selected image frames (operation S240) in a case when an indeterminate type of variations occurs will now be described in detail with reference to FIGS. 31 through 33.

Referring to FIG. 31, a plurality of image frames 1 through k each including a defect region image 410 and a normal region image 411 are obtained (operation S220), the image frames g through h, and i through j having relatively high contrasts are selected from among the image frames 1 through k (operation S230), and images 400 and 401 of a semiconductor device are obtained by integrating the selected image frames g through h, and i through j (operation S240).

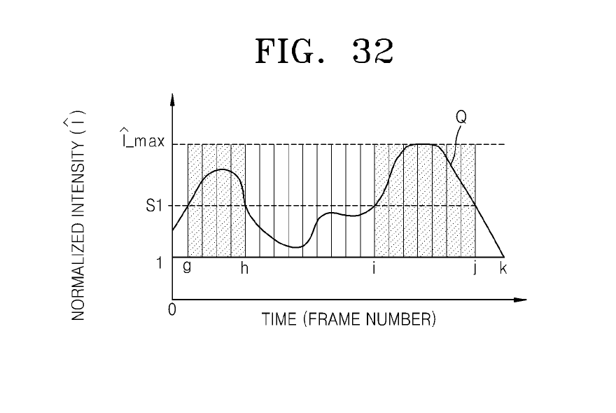

Referring to FIG. 32, unlike the above-described four determinate types of variations, an indeterminate type of variations in normalized intensity of image frames according to an order of time occurs.

Also, the image frames g through h, and i through j having relatively high normalized intensities are selected from among the image frames 1 through k (operation S230) based on normalized intensities equal to or greater than a threshold constant S1.

An average value of the normalized intensities of the selected image frames g through h, and i through j is as represented in Equation (8).

$${\hat{I}}_{AVG ( g - h , i - j )} ( x , y ) = \frac{{\sum }_{m = g}^{h} {\hat{I}}_{m} ( x , y ) + {\sum }_{m = i}^{j} {\hat{I}}_{m} ( x , y )}{( h - g ) + ( i - j ) + 2} \qquad ( 8 )$$

Since the average value of the normalized intensities according to Equation (8) is greater than that according to Equation (3), an ultimate or final image of a semiconductor device, which is obtained by integrating the selected image frames g through h, and i through j, has a greater contrast between a defect region image and a normal region image than an ultimate or final image of a semiconductor device which is obtained by integrating all of the image frames 1 through k.

Also, if the threshold constant is S1 and it is determined that an increase in the contrast of the ultimate or final image of the semiconductor device is further required, the threshold constant may be reset as S2, which is greater than S1, and the ultimate or final image of the semiconductor device may be obtained by re-selecting image frames.

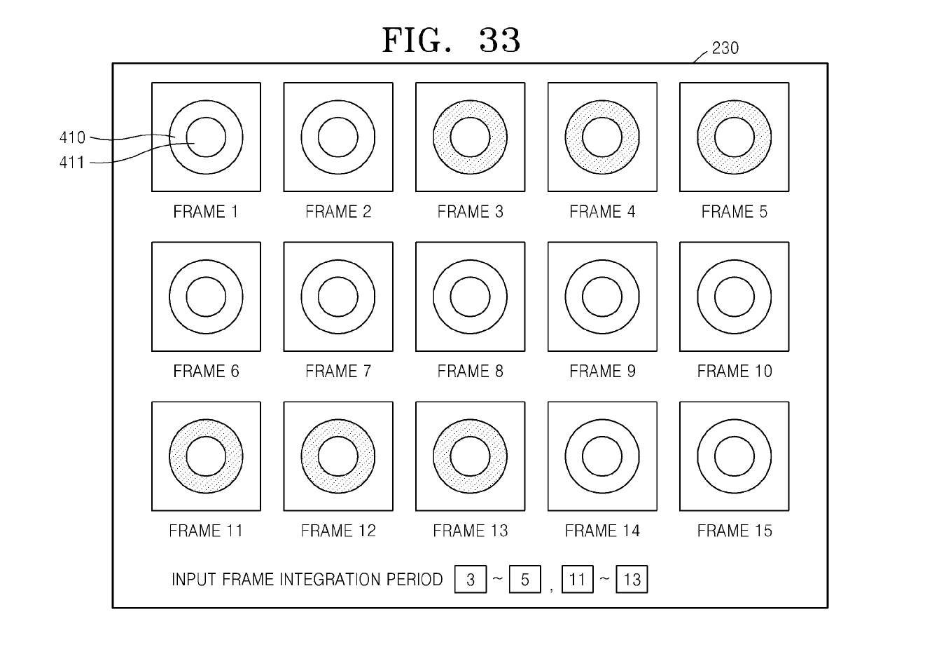

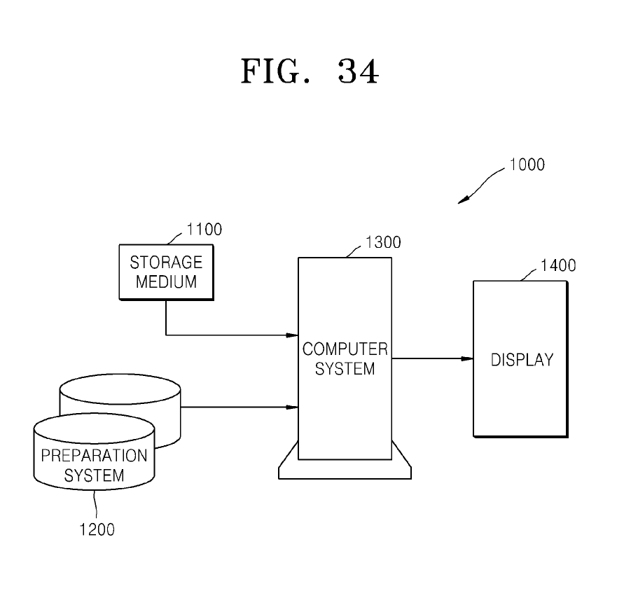

Referring to FIG. 33, image frames 3 through 5, and 11 through 13 having relatively high contrasts are selected from among a plurality of image frames 1 through 15 (operation S230).

The aligned image frames 1 through 15 are the image frames described above in relation to FIGS. 31 and 32. In particular, it is exemplarily assumed that frame numbers g, h, i, j, and k in FIGS. 31 and 32 are frame numbers 3, 5, 11, 13, and 15 in FIG. 33, respectively.

A user may check with their bare eyes the contrast between region of interest image 410 and peripheral region image 411 in each of the image frames 1 through 15 aligned according to an order of time on display screen 230 of the display apparatus. As illustrated in FIG. 32, the contrast is relatively high in the image frames 3 through 5, and 11 through 13.

In this case, in order to optimize the contrast between an image corresponding to a region of interest and an image corresponding to a peripheral region in an ultimate or final image of a semiconductor device, the user may form the ultimate or final image of the semiconductor device by selecting and integrating only the image frames 3 through 5, and 11 through 13. Also, the user may form the ultimate or final image of the semiconductor device by directly inputting on display screen 230 a frame integration period, i.e., frame numbers of the selected image frames. If it is determined that an increase in the contrast of the image obtained by selecting and integrating the image frames 3 through 5, and 11 through 13 is further required, the user may reset the frame integration period.

FIG. 34 is a schematic diagram of a system 1000 for performing a method of forming an image of a semiconductor device or a method of detecting a defect of a semiconductor device.

Referring to FIG. 34, a computer system 1300 for performing the image forming method or the defect detecting method may be a general-use computer or workstation. Computer system 1300 may be of a stand alone type or a network type, may include a single processor or a plurality of processors for calculations, and may be a parallel processing computer system. Computer system 1300 executes a series of executable commands recorded in a program storage medium 1100 such as a compact disk (CD) or a digital video disk (DVD), or transmitted through a wired or wireless communication network such as the Internet. In computer system 1300, a preparation unit 1200 prepares a semiconductor device including a region of interest and a peripheral region, scans and irradiates an electron beam E onto the semiconductor device, receives information regarding collected particles, and processes the information. By using the information regarding the particles, computer system 1300 obtains a plurality of image frames each including a region of interest image and a peripheral region image respectively corresponding to a region of interest and a peripheral region, selects at least some of the image frames, obtains an image of the semiconductor device by integrating the selected image frames, and then generates a file including information regarding the image of the semiconductor device. The information regarding the image of the semiconductor device is transmitted to a display apparatus 1400 and thus the image of the semiconductor device may be checked on display apparatus 1400 with their bare eyes.

System 1000 may include a preparation mechanism for preparing a semiconductor device including a region of interest and a peripheral region, an obtaining mechanism for obtaining a plurality of image frames each including a region of interest image and a peripheral region image respectively corresponding to the region of interest and the peripheral region, a selection mechanism for selecting at least some of the image frames, and a forming mechanism for forming an image of the semiconductor device by integrating the selected image frames.

A method of forming an image of a semiconductor device or a method of detecting a defect of a semiconductor device, as described above, can also be implemented as computer-readable codes on a computer-readable medium. The computer-readable medium may be any data storage device that can store a program or data which can be thereafter read by a computer system, and in particular may be a tangible computer-readable medium. Examples of the tangible computer-readable medium include read-only memory (ROM), random-access memory (RAM), CD-ROMs, DVDs, magnetic tapes, floppy disks, optical data storage devices, flash memory, etc. The computer-readable medium can also be distributed over network coupled computer systems so that the computer readable code is stored and executed in a distributed fashion. Here, a program stored in a recording medium is expressed in a series of instructions used directly or indirectly within a device with a data processing capability, such as, computers. Thus, a term “computer” involves all devices with data processing capability in which a particular function is performed according to a program using a memory, input/output devices, and arithmetic logics.

The computer-readable medium may store programmed commands for executing every step of a method of forming an image of a semiconductor device or a method of detecting a defect of a semiconductor device, the method including preparing a semiconductor device including a region of interest and a peripheral region, obtaining a plurality of image frames each including a region of interest image and a peripheral region image respectively corresponding to the region of interest and the peripheral region, selecting at least some of the image frames, and obtaining an image of the semiconductor device by integrating the selected image frames, when the method is executed by a computer.

While the inventive concept has been particularly shown and described with reference to exemplary embodiments thereof, it will be understood that various changes in form and details may be made therein without departing from the spirit and scope of the following claims.

What is claimed is:

1. A method of forming an image of a semiconductor device, the method comprising:
providing a semiconductor device comprising a region of interest and a peripheral region;
obtaining a plurality of image frames each comprising a region of interest image and a peripheral region image respectively corresponding to the region of interest and the peripheral region;
selecting at least some of the plurality of image frames; and
obtaining an image of the semiconductor device by integrating the selected image frames.

2. The method of claim 1, wherein selecting at least some of the plurality of image frames comprises selecting at least some of the plurality of image frames based on a contrast between the region of interest image and the peripheral region image.

3. The method of claim 2, wherein the plurality of image frames comprise image frames whose contrasts vary according to time.

4. The method of claim 2, wherein the contrast between the region of interest image and the peripheral region image comprises a normalized intensity that is a ratio of an intensity of particles emitted from the region of interest to an intensity of particles emitted from the peripheral region.

5. The method of claim 4, wherein the selecting of at least some of the plurality of image frames comprises:
calculating the normalized intensity of each of the image frames; and
selecting from among the plurality of image frames image frames having normalized intensities equal to or greater than a first threshold,
wherein the first threshold is β×Î_max, where Î_max is a maximum value from among the normalized intensities according to time and where β is greater than 0 and equal to or less than 1.

6. The method of claim 5, further comprising:
re-selecting from among the plurality of image frames image frames having normalized intensities equal to or greater than a second threshold constant; and
re-obtaining the image of the semiconductor device by integrating the re-selected image frames,
wherein the second threshold constant is γ×Î_max, where Î_max is a maximum value from among the normalized intensities according to time and γ is greater than β and equal to or less than 1.

7. The method of claim 1, wherein the selecting of at least some of the plurality of image frames comprises:
displaying the plurality of image frames on a display screen; and
selecting from among the plurality of image frames on the display screen those image frames having highest contrasts between the region of interest image and the peripheral region image.

8. The method of claim 1, wherein the plurality of image frames are obtained by using particles emitted when an electron beam is irradiated onto the semiconductor device.

9. The method of claim 8, wherein the particles are at least one of secondary electrons, backscattered electrons, Auger electrons, diffracted electrons, and transmitted electrons.

10. The method of claim 1, wherein the region of interest comprises a defect region having a defect, and wherein the peripheral region comprises a normal region having no defect.

11. The method of claim 10, wherein the normal region is adjacent to the defect region.

12. A method of detecting a defect of a semiconductor device, the method comprising:
providing a semiconductor device comprising a defect region and a normal region;
obtaining a plurality of image frames each comprising a defect region image and a normal region image respectively corresponding to the defect region and the normal region;
selecting at least some of the plurality of image frames; and
obtaining an image of the semiconductor device by integrating the selected image frames.

13. The method of claim 12, wherein selecting at least some of the plurality of image frames comprises:
checking variations in contrast between the defect region image and the normal region image in the plurality of image frames; and
selecting at least some of the plurality of image frames based on the contrast.

14. The method of claim 13, wherein checking the variations in contrast between the defect region image and the normal region image in the plurality of image frames comprises checking variations in a normalized intensity, which is a ratio of an intensity of particles emitted from the defect region to an intensity of particles emitted from the normal region.

15. The method of claim 14, wherein, when the variations in the normalized intensity are higher in a first time period than in a second time period, selecting at least some of the plurality of image frames comprises selecting image frames corresponding to the first time period.

16. A system, comprising:
a device configured to cause particles to be emitted from a sample semiconductor device including a region if interest and a peripheral region disposed outside the region of interest;
a detection unit configured to detect the particles emitted from the region of interest and the particles emitted from the peripheral region; and
a processor configured to execute an algorithm comprising:
obtaining a plurality of image frames from the detected particles, each of the image frames comprising a region of interest image and a peripheral region image respectively corresponding to the region of interest and the peripheral region of the semiconductor device;
selecting at least some of the plurality of image frames based on a contrast ratio of each image frame between the region of interest image and the peripheral region image; and
obtaining an image of the semiconductor device by integrating the selected image frames.

17. The system of claim 16, wherein the processor selects at least some of the plurality of image frames based on a contrast ratio of each image frame between the region of interest image and the peripheral region image by:
calculating a normalized intensity of each of the image frames as a ratio of an intensity of the particles detected from the region of interest to an intensity of the particles detected from the peripheral region; and
selecting from among the plurality of image frames image frames having normalized intensities equal to or greater than a first threshold,
wherein the first threshold is β×Î_max, where Î_max is a maximum value from among the normalized intensities of all of the image frames, and where β is greater than 0 and equal to or less than 1.

18. The system of claim 16, wherein the particles are X-rays.

19. The system of claim 16, wherein the particles are electrons.

20. The system of claim 16, further comprising a display screen configured to display the image of the semiconductor device.
